(19) United States
(12) Patent Application Publication
(10) Pub. No.: US 2016/0060466 A1
(43) Pub. Date: Mar. 3, 2016

(54) Aluminizing Coating Nanosystem Having Anti-Corrosion, Anti-Scratch and Anti-UV Properties

(71) Applicant: NanoTech Innovations Corporation, McAllen, TX (US)

(72) Inventor: Victor Manuel CASTAÑO MENESES, Queretaro (MX)

(73) Assignee: NANOTECH INNOVATIONS CORPORATION, McAllen, TX (US)

(21) Appl. No.: 14/469,723

(22) Filed: Aug. 27, 2014

(51) Int. Cl. C09D 5/10; C09D 175/04; C09D 7/00

(52) U.S. Cl. CPC C09D 5/103; C09D 7/001; C09D 175/04; C08K 2003/0812

(57) ABSTRACT

The present invention discloses an aluminizing coating nanosystem which comprises a mixture of nanoparticles, a prepolymer, an aluminum leafing pigment, and a diluent; having anti-corrosion, anti-scratch, anti-UV and high flexibility properties.

### FIELD OF THE INVENTION

The present invention is related to the development of nanosystems for protection against corrosion and other physical and chemical threats affecting pipelines.

### BACKGROUND OF THE INVENTION

The present invention is a technology-oriented protection against corrosion phenomena taking place in the global oil industry, in this regard, Arora and Pandey (2012) point out that “ . . . oil industry is characterized by high corrosion activity of media at all stages of production, transportation and processing of oil. In this industry the corrosive wear determines the duration and fail-safety of equipment, duration of overhaul periods and expenses of equipment repairs. Losses causes by corrosion consist not only of the loss of metal mass but also cause worsening of equipment functional properties.”

Moreover Brondel and others (1994) reported that corrosion costs 170 billion dollars a year to the U.S. Industry. Similarly El-Meligi (2010) notes that: “The Corrosion of materials cost the national income of developed countries (GDP) losses of 3-4%. Every year, billions of dollars are spent on capital replacement and control methods for corrosion infrastructure. Preventing corrosion is a crucial need to protect the environment and the economy. Accordingly, better corrosion management can be achieved using preventive strategies in nontechnical and technical areas. Therefore, many environmental protection legislation raised to prevent using the environmentally unacceptable materials such as the use of chromium salts is now restricted because chromium (Cr⁺⁶) is highly toxic and carcinogenic. Rare earth elements can replace the chromium salts as corrosion inhibitors. Environmentally friendly compounds used in coating process are used to avoid the harmful effects of the currently used compounds.”

Methods and coatings for anti-corrosion protection have been developed over the years. U.S. Pat. No. 4,606,953; U.S. Pat. No. 7,169,480; CN1327979-C; GB2303896-B; EP1276823 B1; CN100413937-C; CN101074338; CN1170902-C; DE10014704-C2; CN103540239-A; CN103045969-A; all provide an extensive background on anti-corrosion protection. However the coatings described under these documents do not sufficiently address the problems related to corrosion affecting pipelines, further providing protection against scratches and ultraviolet rays and reducing the risks against the environment and public health.

### BRIEF SUMMARY OF THE INVENTION

The current invention relates to a nanosystem for protection against corrosion and other physical and chemical threats affecting pipelines. Such nanosystem forming an aluminizing coating against moisture, oils, fuels and other chemicals, while generating a surface tension effect that “pushes” the aluminum particles of micro and nano scale toward the outer coating such that aluminizing coating is formed.

In certain aspects, the present invention is directed to an aluminizing coating nanosystem, comprising: a) a mixture of nanoparticles, b) a prepolymer, c) a leafing aluminum pigment and d) a diluent.

The aluminizing coating system according to the invention exhibits improved anti-corrosion, anti-scratch, anti-UV and high flexibility properties.

In addition, the aluminizing coating nanosystem of the invention provides an alternative environment-friendly and without risk to health, to cope with corrosion in the oil industry.

In another aspect, the invention can feature the mixture of nanoparticles including aluminum oxide nanoparticles, zinc oxide nanoparticles, titanium dioxide nanoparticles, silicon dioxide nanoparticles and carbonaceous nanoparticles.

In another aspect, the invention can feature the aluminizing coating nanosystem further including cerium oxide nanoparticles, magnesium oxide nanoparticles, zirconium oxide nanoparticles or a mixture thereof.

In another aspect, the invention can feature the prepolymer being an aromatic polyisocyanate compound, selected from diphenylmethane diisocyanate or toluene diisocyanate.

In another aspect, the invention can feature the aluminum leafing pigment being in paste form.

In another aspect, the invention can feature the ratio of the leafing pigment to the prepolymer being from about 1:3 to 3:1.

In another aspect, the invention can feature the diluent being a bio-sustainable solvation agent, other than water.

In another aspect, the invention can feature the bio-sustainable solvation agent being selected from esters, methyl esters, ethyl esters, propyl esters or polyesters of natural essential oils, or polyunsaturated glycerol triesters.

In another aspect, the invention can feature the natural essential oil being selected from soy oil, castor oil, chia oil, safflower oil or sesame oil.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### DETAILED DESCRIPTION OF THE INVENTION

The present invention provides an aluminizing coating nanosystem having improved anti-corrosion, anti-scratch and anti-UV properties; while reducing environmental and health risks.

One embodiment of the invention includes an aluminizing coating nanosystem comprising: a) a mixture of nanoparticles, b) a prepolymer, c) a leafing aluminum pigment and d) a diluent.

The nanoparticles confer to the polymeric matrix a substantial improvement in the thermal and physical-mechanical properties, derived from their particle size and surface activity.

One of its features is to encapsulate the iron oxide formed by generating a physical and chemical anchoring, which is caused by the chemical nature of the nanoparticles used in combination with the polymer, so that not only an anticorrosive effect is achieved but also cathodic activity at nanoscale whereby oxidation to infiltrate across the surface stops. After migrating the solvent, it is degraded within a short period of time, thus, it is considered a bio-sustainable product.

In one embodiment of the invention, the nanoparticles mixture comprises aluminum oxide (Al₂O₃), zinc oxide (ZnO), titanium dioxide (TiO₂), silicon dioxide (SiO₂), and carbonaceous nanoparticles. In a preferred embodiment of the invention the carbonaceous nanoparticles are diamond nanoparticles.

In another embodiment of the invention, the coating nanosystem may also comprise additional nanoparticles such as cerium oxide (Ce₂O₃), magnesium oxide (MgO), zirconium oxide (Zr₂O₃) or a combination thereof.

Nanoparticles have a particle diameter of no more than 100 nm, preferable between 1 to 20 nanometers. The nanoparticles may be present in about 0.5% to about 10% by weight. Commercially available oxide nanoparticles, such as NANOBYK-3610®, may be used, without limitation of chemical nature of the vehicle and wherein the proportion of nanoparticles/vehicle is in a range from 9:1 to 1:9.

The prepolymer is an aromatic polyisocyanate compound, selected from diphenylmethane diisocyanate (MDI) or toluene diisocyanate (TDI). Examples include DESMODUR®, and MONDUR®, commercially available from Bayer. Said prepolymer is in an amount range between 10 and 90% by weight, preferably from 15 to 40%.

The aluminizing coating nanosystem also comprises aluminum pigments having a leafing effect in which surface tension pulls the aluminum particles of micro and nanoscale, toward the outer coating.

Aluminum pigments obtain their “leafing” property during their production, in a process of humid milling in suitable solvents and with the fatty acids addition that gives to particles this property.

The “leafing” pigments present a typical property of flotation in the humid film, due to the high superficial tension and tend to orient themselves in horizontal form on the surface of the vehicle. Due to this influence of the superficial tension between the metallic pigment and the vehicle, the particles in form of flakes and irregular contour, get suspended and create the optical impression of a metallic surface with a high degree of light reflection and silver-plated appearance.

Commercially available leafing aluminum pigments are suitable for the formulation, For example leafing aluminum pigment in paste, such as METAPOL GAP 8. The amount of leafing aluminum pigment may range from 10 to 90% by weight, preferably from 15 to 40%.

In certain embodiment of the invention, the ratio of aluminum pigment to the prepolymer is from 1:3 to 3:1; and preferably 1:1.

Diluents are characterized by being non-toxic, biodegradable, eco-friendly solvents, particularly biosustainble solvation agents other than water. Suitable diluents are selected from esters, methyl esters, ethyl esters, propyl esters or polyesters of natural essential oils, or polyunsaturated glycerol triesters. Natural essential oils may be selected from soy oil, castor oil, chia oil, safflower oil or sesame oil.

Further suitable diluents are commercially available products such as Augeo® and Rhodiasolv® from Rhodia Group.

The present invention is advantageous because the constituents of the aluminizing coating system provide synergistic results with respect to corrosion-resistance, scratch resistance and UV protection. In addition, aluminizing coating nanosystems, according to the present invention, exhibit good coating properties including hardness, high flexibility, good durability, excellent anchorage, waterproof, resistance to friction, resistance to strong acids and alkali vapors, acting as a protective layer, and easy to apply.

The aluminizing coating nanosystem, according to the present invention, forms a film coating actually protects the metal substrates in three ways:
i This protection system reduces diffusion of water and oxygen from the atmosphere to the surface of metal. This limits the electrolyte available to complete the pattern from corrosion.
ii The protective layer formed decreases the diffusion rate of corrosion products from the metal surface through said protective film. This important step limits the electron flow preventing corrosion.
iii Anti-corrosive components containing in the aluminizing nanosized system changes the properties of the metal base surface. The result of this change is that the metal develops a high electrical resistance that blocks the corrosion process by sticking to the metal surface so that block the ability of oxygen to collect electrons, by creating so thick oxide films that are poor conductors of electrons or by reacting with the surface ions as chlorides or sulfates to form insoluble salts, preventing the harmful effects of these pollutants.

In other words, a reduction in current flow in the electrochemical corrosion process substantially reduces the corrosion rate of the metal.

The present invention also disclosed a method for forming an aluminizing coating, comprising the steps of:

a) providing an aluminizing coating nanosystem,
b) applying the aluminizing coating nanosystem to a substrate; and
c) forming an aluminizing coating against moisture, oils, fuels and other chemicals while generating a surface tension effect that “pushes” the aluminum particles of micro and nano scale toward the outer coating; wherein the aluminizing coating possesses anti-corrosion, anti-scratch and offers UV protection; and wherein aluminizing coating nanosystem comprises nanoparticles; a prepolymer, an aluminum leafing pigment, and a diluent.

The coating system may be applied in temperature conditions about 220° C.

The method may further comprise a pretreatment step for surface preparation before step (b). Said surface preparation may be manual of mechanic to remove impurities, such as residues of soldering, oxidation, aging and other fouling paint.

The present invention is illustrated, but not limited by the following examples:

### Example 1

An aluminizing coating system comprising:

| Component | % weight |
|---|---|
| Aluminum leafing pigment | 20% |
| Prepolymer (Desmodur E21) | 20% |
| Diluent (Augeo) | 59.5% |
| Aluminum oxide nanoparticles | 0.10% |
| Titanium dioxide nanoparticles | 0.10% |
| Zinc oxide nanoparticles | 0.10% |
| Silicon dioxide nanoparticles | 0.10% |
| Diamond nanoparticles | 0.10% |

The composition was prepared by mixing aluminum leafing pigment with a diluent at low speed, from 500 to 800 rpm, followed by addition of the prepolymer under inert atmosphere, and nanoparticles.

### Example 2

The aluminizing coating nanosystem according to the invention was compared to known coatings used in oil industry to prevent corrosion. Tables 1 to 3 show the physical properties that must be met in a coating for corrosion protection, showing that the present invention achieves significant improvements in corrosion protection, and also in adhesion to the substrate and high flexibility that allows working under severe conditions of use.

TABLE 1

| | | | Optimal | % of |
|---|---|---|---|---|
| | | Tools and | time for | Permissible |
| | Dry Film | spacing of | the test | Area |
| Coating type | Thickness | grooves | (hr) | detached |
| Zinc chromate | 3 | Knife, 3 mm | 72 | 5% |
| Post-curing, | 2-3 | Metallic Tool | 72 | Note¹ |
| inorganic zinc | | | | |
| self-curing, | 2-3 | Metallic Tool | 72 | Note¹ |
| inorganic zinc | | | | |
| Coal Tar Epoxy | 12-16 | Knife, 3 mm | 168 | 0% |
| Catalyzed Epoxy | 2 | Knife, 1 mm | 168 | 0% |
| Modified Epoxy | 2 | Knife, 1 mm | 72 | 5% |
| Chlorinated rubber | 2 | Knife, 1 mm | 72 | 5% |
| Amine Adduct | 3-4 | Knife, 2 mm | 168 | 5% |
| Epoxy | | | | |
| Aluminizing | 3-4 | Knife, 1 mm | 72 | 0% |
| coating nanosystem | | | | |

¹Zinc inorganic coating must not present removal of dust on the surface coated by scratching the surface with a metal tool.

TABLE 2

| | | Adhesion Level |
|---|---|---|
| Coating type | % Elongation | (kg) |
| Zinc chromate | 10 | 4 |
| Post-curing, | 0 | 8 |
| inorganic zinc | | |
| self-curing, | 0 | 6 |
| inorganic zinc | | |
| Coal Tar Epoxy | 5 | 8 |
| Catalyzed Epoxy | 10 | 8 |
| Modified Epoxy | 10 | 4 |
| Chlorinated rubber | 10 | 4 |
| Amine Adduct | 5 | 8 |
| Epoxy | | |
| Aluminizing | 15 | 8 |
| coating nanosystem | | |

TABLE 3
Corrosion test

| | | Weatherometer |
|---|---|---|
| | Saline Cabinet | Cycle of 102/18 min |
| Coating type | (hours) | (Hours) |
| Zinc chromate | 200 | 300 |
| Post-curing, inorganic zinc | 2000 | 2000 |
| self-curing, inorganic zinc | 500 | 700 |
| Coal Tar Epoxy | 750 | 750 |
| Catalyzed Epoxy | 300 | 500 |
| Modified Epoxy | 200 | 300 |
| Chlorinated rubber | 200 | 500 |
| Amine Adduct Epoxy | 600 | 500 |
| Aluminizing coating | 4000 | 6000 |
| nanosystem | | |

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An aluminizing coating nanosystem, having anti-corrosion, anti-scratch and anti-UV properties; which comprises: a) a mixture of nanoparticles; b) a prepolymer, c) an aluminum leafing pigment, and d) a diluent.

2. The aluminizing coating nanosystem of claim 1, wherein the mixture of nanoparticles comprises aluminum oxide nanoparticles, zinc oxide nanoparticles, titanium dioxide nanoparticles, silicon dioxide nanoparticles and carbonaceous nanoparticles.

3. The aluminizing coating nanosystem of claim 2, further comprising cerium oxide nanoparticles, magnesium oxide nanoparticles, zirconium oxide nanoparticles or a mixture thereof.

4. The aluminizing coating nanosystem of claim 1, wherein the prepolymer is an aromatic polyisocyanate compound, selected from diphenylmethane diisocyanate or toluene diisocyanate.

5. The aluminizing coating nanosystem of claim 1, wherein the aluminum leafing pigment is in paste form.

6. The aluminizing coating nanosystem of claim 1, wherein the ratio of the leafing pigment to the prepolymer is from 1:3 to 3:1.

7. The aluminizing coating nanosystem of claim 1, wherein the diluent is a bio-sustainable solvation agent, other than water.

8. The aluminizing coating nanosystem of claim 7, wherein the bio-sustainable solvation agent is selected from esters, methyl esters, ethyl esters, propyl esters or polyesters of natural essential oils, or polyunsaturated glycerol triesters.

9. The aluminizing coating nanosystem of claim 8, wherein the natural essential oil is selected from soy oil, castor oil, chia oil, safflower oil or sesame oil.
